(19) United States
(12) Patent Application Publication
(10) Pub. No.: US 2019/0136621 A1
(43) Pub. Date: May 9, 2019

(54) FOLDING LADDER

(71) Applicant: JIAXING JACKSON TRAVEL PRODUCTS CO., LTD, Jiaxing (CN)

(72) Inventors: Xuelin ZHU, Jiaxing (CN); Jing LI, Jiaxing (CN)

(21) Appl. No.: 16/180,769

(22) Filed: Nov. 5, 2018

(30) Foreign Application Priority Data
Nov. 6, 2017 (CN) 201721461915.8

(51) Int. Cl. E06C 1/16; E06C 1/393; E06C 7/16; E06C 7/50

(52) U.S. Cl. CPC E06C 1/16; E06C 7/50; E06C 7/16; E06C 1/393

(57) ABSTRACT

The invention provides a folding ladder. The folding ladder comprises a front frame, a rear frame, a pedal and a locking mechanism for locking the pedal flipping, the front frame is rotatably connected with the rear frame, the pedal is rotatably connected with the front frame, the rear frame is provided with a crossbar and the pedal can be flipped to the crossbar, after the pedal is flipped to the crossbar, the locking mechanism can lock the pedal, wherein the locking mechanism comprises a hook member, a snap portion that snaps the hook member, and a control member that controls the disengagement of the hook member and the snap portion; the hook member is provided with a barb that is engaged with the snap portion, there are one or two or more barbs; the snap portion is disposed on the pedal, and the hook member is disposed on the rear frame; or the positions of the snap portion and the hook member are interchanged.

### RELATED APPLICATION

This application claims priority to Chinese Application Serial No. 201721461915.8, filed on Nov. 6, 2017, which is herein incorporated by reference in its entirely.

### FIELD OF THE INVENTION

The present utility model relates to a folding ladder, and it belongs to the technical field of household products.

### BACKGROUND OF THE INVENTION

The existing folding ladder comprises a frame with a front leg and a rear leg. The rear leg is coupled to the front leg, and the front and rear legs can be pivoted relative to each other between the opening position and the closing position. A pedal connected to the front leg is assembled, and the pedal can be relatively pivoted between the horizontal use position and the storage position; a connector is assembled, and the connector comprises a body and a shaft connected to the body and the pedal; a joint elbow connected to the body is assembled. When the joint elbow is trigged to engage with the rear leg and the pedal is moved from the horizontal use position to the storage position, the rear leg can move from the opening position to the closing position correspondingly. In the above technical solution, the connector is rotationally connected with respect to the pedal, and the structure necessarily requires a reset elastic member similar to torsion ring. The connection between the pedal and the rear leg needs to rely on the torsion spring, so the structure is complicated to assemble, with high manufacturing cost.

### SUMMARY OF THE INVENTION

It is an object of the present utility model to overcome the drawbacks of the prior art and provide a folding ladder with reasonable structural design and low production cost.

To achieve the above object, the present utility model adopts the following technical solution:

A folding ladder comprises a front frame, a rear frame, a pedal and a locking mechanism for locking the pedal flipping, the front frame is rotatably connected with the rear frame, the pedal is rotatably connected with the front frame, the rear frame is provided with a crossbar and the pedal can be flipped to the crossbar, after the pedal is flipped to the crossbar, the locking mechanism can lock the pedal. The locking mechanism comprises a hook member, a snap portion that snaps the hook member, and a control member that controls the engagement and/or disengagement of the hook member and the snap portion; the hook member is provided with a barb that is engaged with the snap portion; the snap portion is disposed on the pedal, and the hook member is disposed on the rear frame; or the positions of the snap portion and the hook member are interchanged; the number of barbs is one or two or more than two.

Further, the snap portion comprises a cavity having a narrow opening and wide inside, after the hook member is embedded in the cavity by overcoming its own elastic resistance, the hook member resets and the hook member is engaged with the snap portion, to lock the pedal, the control member controls the opening of the snap portion to become large, so that the snap portion and the hook member are disengaged.

Further, the snap portion comprises a cavity having a narrow opening and wide inside, after the hook member is embedded in the cavity by overcoming its own elastic resistance, the hook member resets and the hook member is engaged with the snap portion, to lock the pedal, the control member controls the hook member to disengage from the snap portion.

Still further, the periphery of the cavity comprises a semi-closed type, and the semi-closed type is a point-and-segment distribution structure of the outer wall of the cavity having a gap space.

Still further, the periphery of the cavity comprises a closed type or semi-closed type, and the closed type is a continuous closed structure of the outer wall of the cavity, and the semi-closed type is a point-and-segment distribution structure of the outer wall of the cavity having a gap space.

Still further, the folding ladder further comprises an elastic member, when the control member moves to the opening of the snap portion by overcoming the resistance of the elastic member, the opening becomes large, and the elastic member exerts a force on the control member to reset it.

Further, the folding ladder further comprises an elastic member, when the control member moves to the hook member by overcoming the resistance of the elastic member, the hook member tends to be disengaged from the snap portion, and the snap portion disengages from the hook member; the elastic member exerts a force on the control member to reset it.

Further, the hook member is an integrally formed plastic member.

Further, the hook member is made of elastic steel wire or steel plate.

Further, the barb is provided with a guide surface that caters to control with the control member.

Compared with the prior art, the present utility model has the following advantages and effects: first, when the pedal of the utility model is flipped to the crossbar, the locking mechanism can lock the pedal, so it needs not redundant operation for locking, just rotating the pedal. The operation is convenient and safe. The locking mechanism is arranged between the pedal and the crossbar, which dramatically reduces the materials and saves the manufacturing costs.

### BRIEF DESCRIPTION OF THE DRAWINGS

FIG. 1 is a schematic structural view of an embodiment of the present utility model.

FIG. 2 is a partially enlarged schematic view showing the portion A of FIG. 1.

FIG. 3 is a schematic structural view showing one barb according to the Example 1 of the present utility model.

FIG. 4 is a schematic structural view showing that the control member controls the snap portion according to the Example 1.

FIG. 5 is a partially enlarged schematic view showing the portion B of FIG. 4.

FIG. 6 is schematic structural view showing that the snap portion is disposed on the crossbar and the hook member is disposed on the pedal.

FIG. 7 is a schematic structural view of the Example 2 of the present utility model.

FIG. 8 is a schematic structural view of another embodiment according to Example 2 of the present utility model.

### DETAILED DESCRIPTION

The present utility model will be further described in detail below with reference to the accompanying drawings and embodiments. The embodiments herein are illustrative but not restrictive to the present utility model.

### EXAMPLE 1

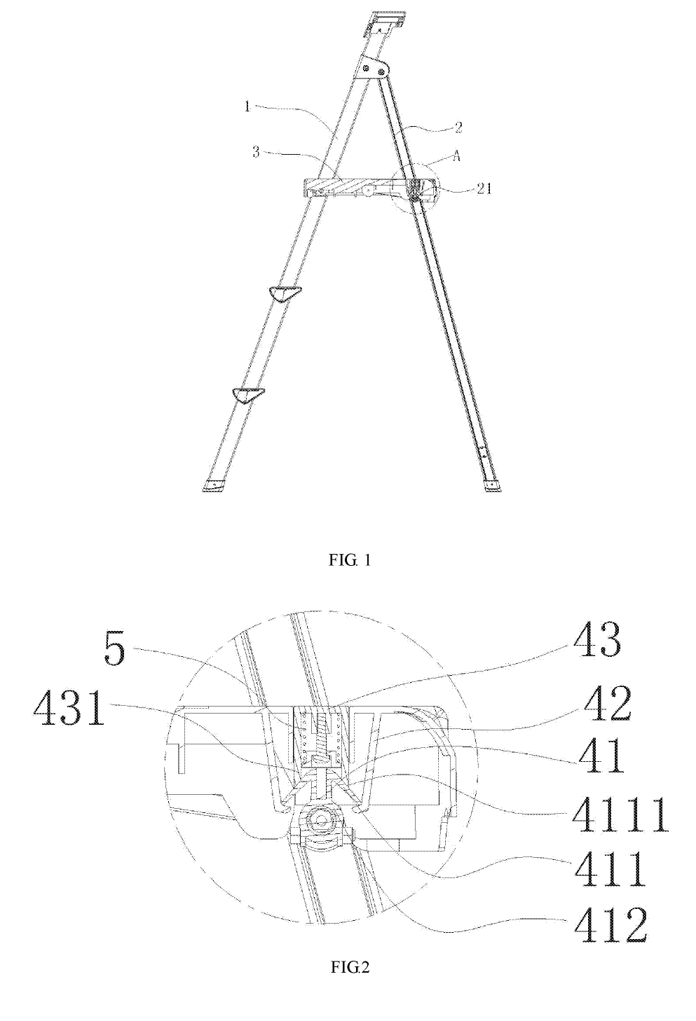

Referring to FIG. 1 to FIG. 6, a folding ladder comprises a front frame 1, a rear frame 2, a pedal 3 and a locking mechanism for locking the flipping of pedal 3, the front frame 1 is rotatably connected with the rear frame 2, the pedal 3 is rotatably connected with the front frame 1, the rear frame 2 is provided with a crossbar 21 and the pedal 3 can be flipped to the crossbar 21, after the pedal 3 is flipped to the crossbar 21, the locking mechanism can lock the pedal 3. The locking mechanism comprises a hook member 41, a snap portion 42 that snaps the hook member 41, and a control member 43 that controls the disengagement of the hook member 41 and the snap portion 42; the hook member 41 is provided with a barb 411 that is engaged with the snap portion 42; the snap portion 42 is disposed on the pedal 3, and snap portion 42 may be a hole formed on the pedal 3, and the hole wall has a stepped structure, which greatly reduces the manufacturing cost, making snapping simple and reliable. The hook member 41 of the embodiment is disposed in the rear frame 2, and the rear frame 2 comprises a body of rear frame 2 and a derivative connector fixedly connected to the rear frame 2, and the derivative connector, for example, is a crossbar 21, and preferably, the hook member in this embodiment 41 is disposed on the crossbar 2 of the rear frame 2, and the hook member 41 corresponds to the position of the snap portion 42, and the pedal 3 can be engaged after being flipped appropriately. The operation is simple and the snapping is reliable.

In this embodiment, the mechanism that controls disengagement of the hook member 41 and the snap portion 42 includes a control member 43 that controls the hook member and a control member 43 that controls the snap portion 42.

Referring to FIG. 1 to FIG. 3, in this embodiment, the method that the control member 43 controls the disengagement of hook member 41 is as follows: after the hook member 41 is embedded in the cavity by overcoming its own elastic resistance, the hook member 41 resets and the hook member 41 is engaged with the snap portion 42, to lock the pedal 3, the control member 43 controls the hook member 41 to disengage from the snap portion 42.

Further, the periphery of the cavity comprises a closed type, and the closed type is a continuous closed structure of the outer wall of the cavity, and the semi-closed type is a point-and-segment distribution structure of the outer wall of the cavity having a gap space. As the hook member 41 is a movable structure that can be deformed, the snap portion 42 of the closed type cavity structure is more beneficial to the stability of snapping.

Still further, the barb 411 is provided with a guide surface 4111 that caters to the snap-in or/and controls the disengagement with the control member 43. In this embodiment, preferably, the guide surface 4111 is a bevel. The barb 411 is provided with a guide surface 4111 that caters to the snap-in. During the engagement of the hook member 41 and the snap portion 42, the hook member 41 and the snap portion 42 are pushed each other, and the guide surface 4111 guides them to the engaged position.

The barb 411 of the embodiment is provided with a guide surface 4111 for engagement and controlling the disengagement with the control member 43. The engagement process is described as above and the disengagement process is as follows: The control member 43 comprises a top arm 431 corresponding to the guide surface 4111, and there is a free space between the top arms 431, and the top arm 431 is provided with a top arm slope corresponding to the guide surface 4111. In addition, it further comprises an elastic member 5. In this embodiment, preferably, the elastic member 5 is a spring, and when the control member 43 moves to the hook member 41 by overcoming the resistance of the elastic member 5, the control member 43 exerts a force on the hook member 41, so that the hook member 41 tends to be disengaged from the snap portion 42, and the snap portion 42 disengages from the hook member 41, and then the elastic member 5 exerts a force on the control member 43 to reset it.

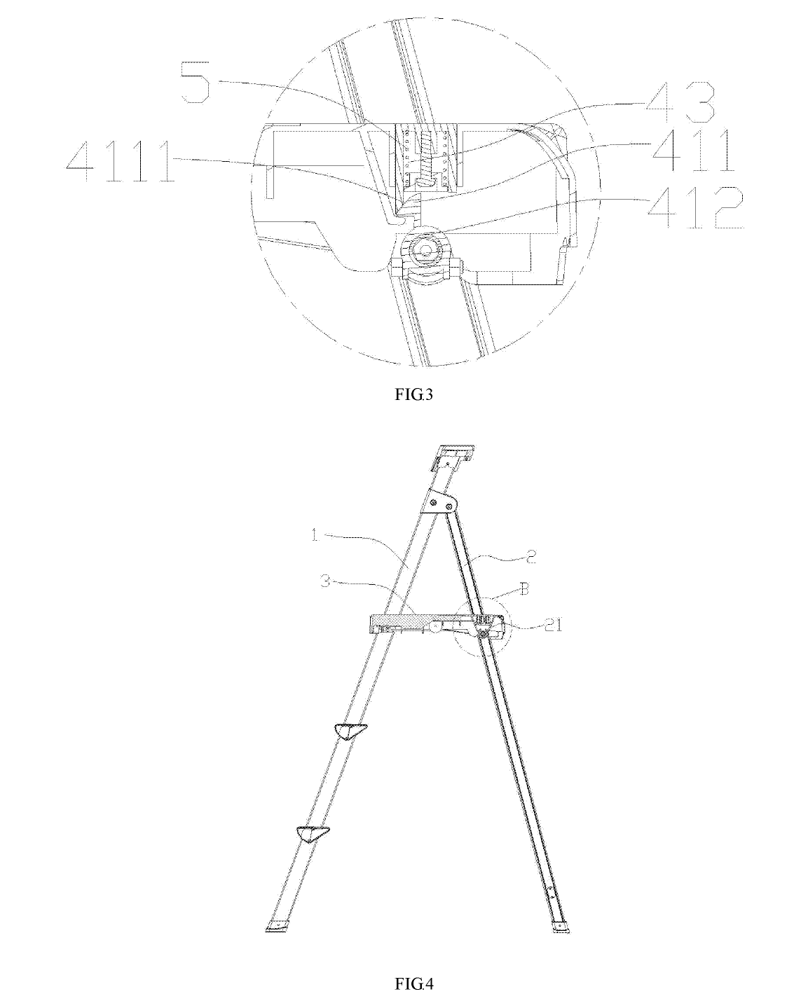

As shown in FIG. 3, when there is one barb 411 and the control member 43 moves toward the hook member 41 by overcoming the resistance of the elastic member 5, the control member 43 exerts a force to the hook member 41, and the hook member 41 tends to be separated from the snap portion 42. When there are two or more barbs 411, it further comprises a base 412 connected to the barb 411. A gap space is provided between the plurality of barbs 411. When the control member 43 moves towards the hook member 41 by overcoming the resistance of the elastic member 5, the top arm 431 abuts against the guide surface 4111 on the barb 411, and the outer diameters of the plurality of barbs 411 are reduced, and the hook member 41 tends to be separated from the snap portion 42, and finally the snap portion 42 and the hook member 41 are disengaged. As shown in FIG. 2, the inside of the guide surface 4111 of the barb 411 has a free space, so the guide surface 4111 has a better elastic deformation effect, with high deformability.

As shown in FIG. 4 to FIG. 5, the method that the control member 43 controls the disengagement of the snap portion 42 is as follows:

The snap portion 42 comprises a cavity having a narrow opening and wide inside. The structure having a narrow opening and wide inside comprises a structure formed by the guide surface 4111 or a hole in which the inner wall of the vertical opening is provided with a convex ring or a hole wall having a stepped mechanism. The periphery of the cavity comprises a closed type or semi-closed type, and the closed type is a continuous closed structure of the outer wall of the cavity, and the semi-closed type is a point-and-segment distribution structure of the outer wall of the cavity having a gap space. The snap portion 42 is disposed at pedal 3, and the hook member 41 is disposed at crossbar 21.

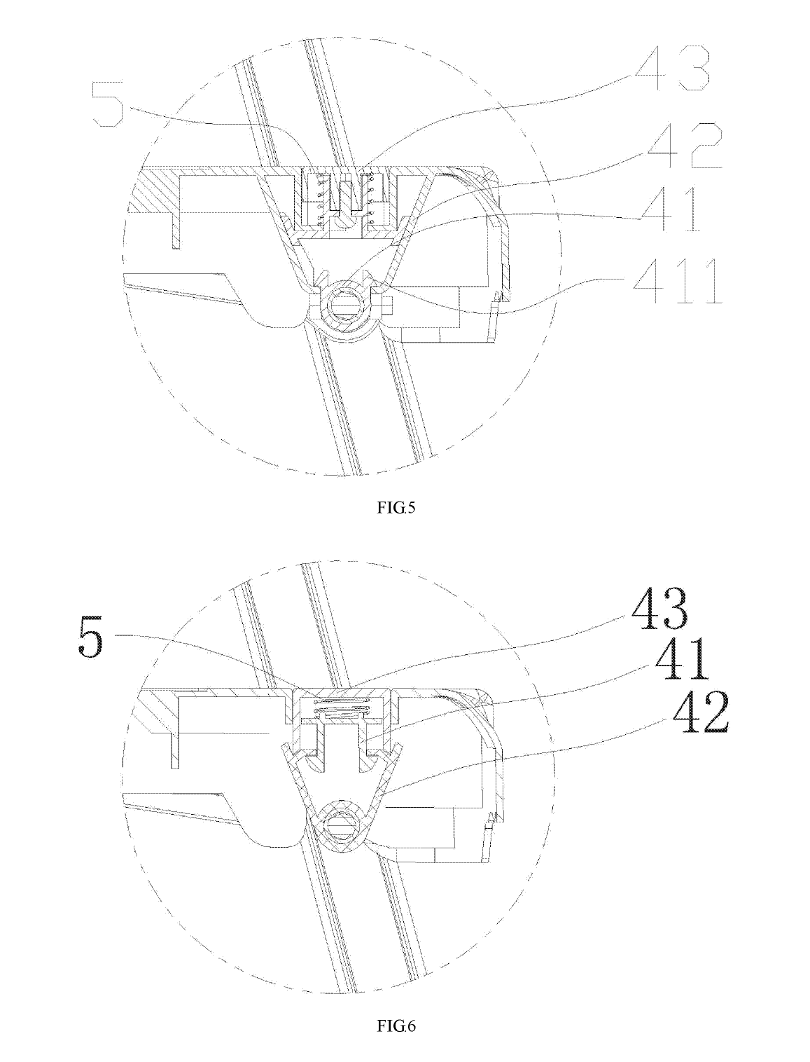

Still further, after the hook member 41 is embedded in the cavity by overcoming its own elastic resistance, the hook member 41 resets, the hook member 41 engages with the snap portion 42, to lock the pedal 3. As shown in FIG. 6, the control member 43 controls the opening of the snap portion 42 to become large, so that the snap portion 42 and the hook member 41 are disengaged. The snap portion 42 comprises a structure having a narrow opening and wide inside formed by the guide surface 4111, and further comprises an elastic member 5 for resetting the control member 43. When the control member 43 moves towards the opening of the snap portion 42 by overcoming the resistance of the elastic member 5, the control member 43 makes the opening to become large, so that the snap portion 42 and the hook member 41 are disengaged. Preferably, in the embodiment, the periphery of the cavity of the snap portion 42 is semi-closed type, and the semi-closed type is a point-and-segment distribution structure with a gap space. The semi-closed type cavity has an adjustable opening diameter, and by adjusting the diameter of the opening, the engagement or disengagement of the snap portion 42 and the hook member 41 is controlled. As shown in FIG. 5, the guide surface 4111 of the barb 411 of this embodiment does not have a free space, so the barb 411 has excellent stability and high mechanical strength.

The hook member 41 in this embodiment is an integrally formed plastic member.

The hook member 41 of this embodiment is made of elastic steel wire or steel plate. The elastic steel wire or steel plate is bent to form the barb 411 and/or the base 412.

The rotary connection in this embodiment is a conventional technical means, including pinning, hinging, riveting, etc.

Another embodiment of the snap portion 42 is that the snap portion 42 is a member that can be hooked securely to the hook member 41, and the member is configured as a cavity or a boss or a rod.

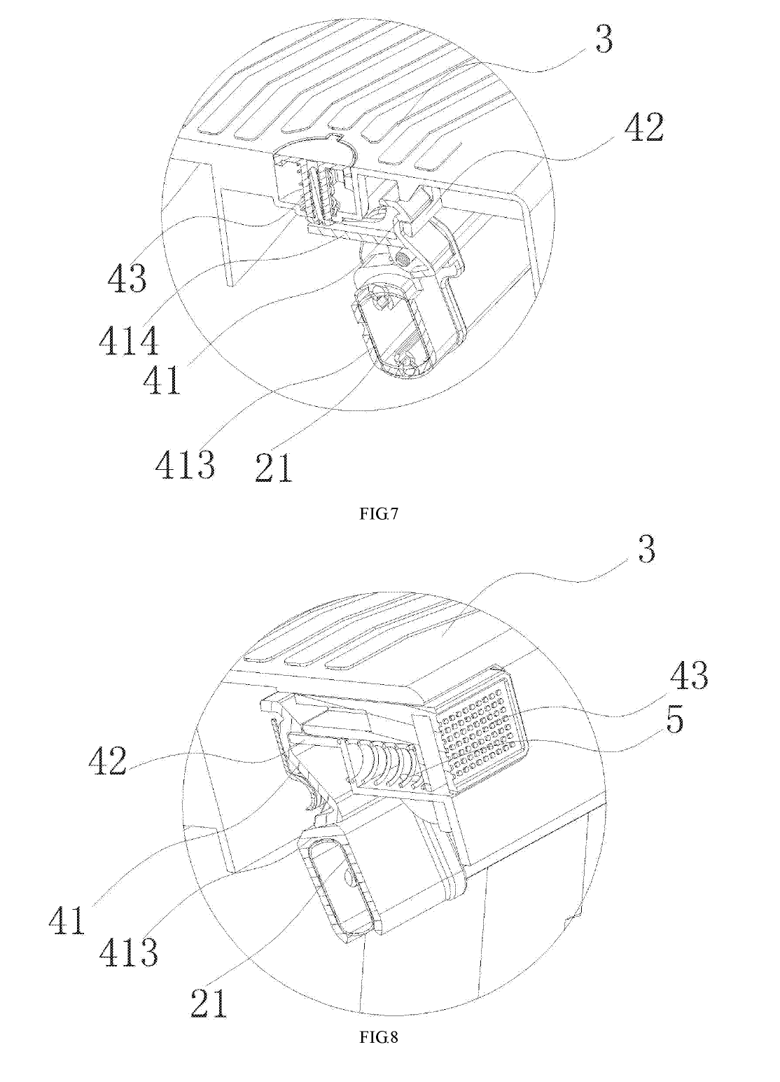

As shown in FIG. 7, the embodiment further comprises a second elastic member that keeps the hook member 41 in a locked state, the hook member 41 is disposed at the crossbar 21, the hook member 41 is rotatably connected to the crossbar 21, and the second elastic member is connected to the hook member 41. The snap portion 42 is disposed in pedal 3, and the control member 43 drives hook member 41 to swing. Preferably, the second elastic member is a torsion spring or an elastic steel piece, and the second elastic member is connected to the hook member 41 at one end and connected to the crossbar 21 at the other end, and the hook member 41 can be reset elastically. During using, when the hook member 41 is engaged with the snap portion 42, the hook member 41 overcomes the resistance of the second elastic member, and after the hook member 41 is in place, the hook member 41 is engaged with the snap portion 42; the control member 43 can drive the hook member to swing back, and the hook member 41 is disengaged from the snap portion 42.

Further, a hook mounting seat 413 for mounting the hook member 41 and an elastic member that exerts force on the control member 43 are provided. The hook mounting seat 413 is fixedly connected to the crossbar 21, and the hook member 41 is pin-connected with the hook mounting seat 413. The control member 43 is disposed on the pedal 3.

In this embodiment, the control member 43 is vertically and movably disposed on the pedal 3. The hook member 41 extends out of a driving rod 414. The control member 43 overcomes the resistance of the elastic member to touch the driving rod 414, so that the hook member 41 swings to the disengagement position.

FIG. 8 shows another setting way of the control member 43. The control member 43 can be horizontally and movably disposed on the pedal 3. The control member 43 overcomes the resistance of the elastic member 5 to touch the hook member 41, so that the hook member 41 swings to the disengagement position. When the control member 43 moves, the hook member 41 is pushed away.

The foregoing descriptions herein are merely illustrative of the utility model. A person skilled in the art can make various modifications or additions to the specific embodiments described or replace them in a similar manner, as long as these modifications, additions or replacements do not deviate from the description or are beyond the scope of the claims of the present utility model, they shall fall within the scope of protection of the present utility model.

1. A folding ladder, comprising a front frame, a rear frame, a pedal and a locking mechanism for locking the pedal flipping, the front frame is rotatably connected with the rear frame, the pedal is rotatably connected with the front frame, the rear frame is provided with a crossbar and the pedal can be flipped to the crossbar, after the pedal is flipped to the crossbar, the locking mechanism can lock the pedal, wherein the locking mechanism comprises a hook member, a snap portion that snaps the hook member, and a control member that controls the disengagement of the hook member and the snap portion; the hook member is provided with a barb that is engaged with the snap portion, there are one or two or more barbs; the snap portion is disposed on the pedal, and the hook member is disposed on the rear frame; or the positions of the snap portion and the hook member are interchanged.

2. The folding ladder according to claim 1, wherein the snap portion comprises a cavity having a narrow opening and wide inside, after the hook member is embedded in the cavity by overcoming its own elastic resistance, the hook member resets and the hook member is engaged with the snap portion to lock the pedal, the control member controls the opening of the snap portion to become large, so that the snap portion and the hook member are disengaged.

3. The folding ladder according to claim 1, wherein the snap portion comprises a cavity having a narrow opening and wide inside, after the hook member is embedded in the cavity by overcoming its own elastic resistance, the hook member resets and the hook member is engaged with the snap portion, to lock the pedal, the control member controls the hook member to disengage from the snap portion.

4. The folding ladder according to claim 2, wherein the periphery of the cavity comprises a semi-closed type, and the semi-closed type is a point-and-segment distribution structure of the outer wall of the cavity having a gap space.

5. The folding ladder according to claim 3, wherein the periphery of the cavity comprises a closed type or semi-closed type, and the closed type is a continuous closed structure of the outer wall of the cavity, and the semi-closed type is a point-and-segment distribution structure of the outer wall of the cavity having a gap space.

6. The folding ladder according to claim 2, wherein the folding ladder further comprises an elastic member, when the control member moves to the opening of the snap portion by overcoming the resistance of the elastic member, the opening becomes large, and the elastic member exerts a force on the control member to reset it.

7. The folding ladder according to claim 3, wherein the folding ladder further comprises an elastic member, when the control member moves to the hook member by overcoming the resistance of the elastic member, the hook member tends to be disengaged from the snap portion, and the snap portion disengages from the hook member; the elastic member exerts a force on the control member to reset it.

8. The folding ladder according to claim 1, wherein the hook member is an integrally formed plastic member.

9. The folding ladder according to claim 1, wherein the hook member is made of elastic steel wire or steel plate.

10. The folding ladder according to claim 1, wherein the barb is provided with a guide surface that caters to the snap-in or/and controls the disengagement with the control member.

11. The folding ladder according to claim 1, wherein the structure of the snap portion is a cavity or a boss or a rod.

12. The folding ladder according to claim 11, wherein the folding ladder further comprises a second elastic member that keeps the hook member in a locked state, the hook member is disposed at the crossbar, the hook member is rotatably connected to the crossbar, and the second elastic member is connected to the hook member, the snap portion is disposed in pedal, and the control member drives hook member to swing.

13. The folding ladder according to claim 11, wherein the folding ladder further comprises a hook mounting seat for mounting the hook member and an elastic member that exerts force on the control member, the hook mounting seat is fixedly connected to the crossbar, and the hook member is pin-connected with the hook mounting seat, the control member is disposed on the pedal.

14. The folding ladder according to claim 11, wherein the control member is vertically and movably disposed on the pedal, the hook member extends out of a driving rod, the control member overcomes the resistance of the elastic member to touch the driving rod, so that the hook member swings to the disengagement position.

15. The folding ladder according to claim 11, wherein the control member can be horizontally and movably disposed on the pedal, the control member overcomes the resistance of the elastic member to touch the hook member, so that the hook member swings to the disengagement position.

16. The folding ladder according to claim 1, wherein the control member can be horizontally and movably disposed on the pedal, the control member overcomes the resistance of the elastic member to touch the hook member, so that the hook member swings to the disengagement position.

17. The folding ladder according to claim 1, wherein the control member is vertically and movably disposed on the pedal, the hook member extends out of a driving rod, the control member overcomes the resistance of the elastic member to touch the driving rod, so that the hook member swings to the disengagement position.

18. The folding ladder according to claim 1, wherein the folding ladder further comprises a hook mounting seat for mounting the hook member and an elastic member that exerts force on the control member, the hook mounting seat is fixedly connected to the crossbar, and the hook member is pin-connected with the hook mounting seat, the control member is disposed on the pedal.

19. The folding ladder according to claim 1, wherein the folding ladder further comprises a second elastic member that keeps the hook member in a locked state, the hook member is disposed at the crossbar, the hook member is rotatably connected to the crossbar, and the second elastic member is connected to the hook member, the snap portion is disposed in pedal, and the control member drives hook member to swing.

20. The folding ladder according to claim 7, wherein the barb is provided with a guide surface that caters to the snap-in or/and controls the disengagement with the control member.
